(19) United States
(12) Patent Application Publication
(10) Pub. No.: US 2012/0258194 A1
(43) Pub. Date: Oct. 11, 2012

(54) PHASEOLUS VULGARIS AS A FUNCTIONAL FOOD INGREDIENT FOR OBESITY AND ASSOCIATED METABOLIC DISORDERS

(75) Inventors: Elizabeth P. Ryan, Wellington, CO (US); John Bauer, College Station, TX (US)

(73) Assignees: THE TEXAS A&M UNIVERSITY SYSTEM, College Station, TX (US); COLORADO STATE UNIVERSITY RESEARCH FOUNDATION, Ft. Collins, CO (US)

(21) Appl. No.: 13/436,542

(22) Filed: Mar. 30, 2012

Related U.S. Application Data
(60) Provisional application No. 61/472,335, filed on Apr. 6, 2011.

(51) Int. Cl. A23L 1/20; A23K 1/14

(52) U.S. Cl. 426/2; 426/634; 426/630

(57) ABSTRACT

Orally ingestible food compositions for mammals are provided for by using Phaseolus vulgaris L. The food compositions include an effective amount of cooked and dehydrated Phaseolus vulgaris L. in an effective amount are disclosed. Methods for treating obesity and/or associated metabolic disorders in mammals are provided for using and orally ingestible food composition using Phaseolus vulgaris L are also disclosed.

### CROSS REFERENCE TO RELATED APPLICATIONS

This application is a non-provisional patent application of and claims the benefit of U.S. Provisional Application No. 61/472,335 filed Apr. 6, 2011, the entire contents of which are incorporated herein by reference for all purposes.

### BACKGROUND

All publications cited in this application are herein incorporated by reference.

Obesity and associated metabolic disorders related to obesity affect nearly half of all domesticated animals. Association for Pet Obesity Prevention (2012). An unhealthy diet or an unhealthy lifestyle can result in an animal being obese and/or having associated metabolic disorders. Commercial development to improve health and prevent disease in canines, for example, has led to the creation of numerous commercial dog foods with novel carbohydrates, fiber, and protein sources.

### SUMMARY

An embodiment of the present invention may comprise an orally ingested food composition containing cooked, dehydrated, and powdered Phaseolus vulgaris.

In certain embodiments, the orally ingested food composition contains at least about 0.1% to 25% weight/weight cooked, dehydrated, and powdered Phaseolus vulgaris of the total food composition.

In certain embodiments, the Phaseolus vulgaris is comprised of navy bean.

In certain embodiments, the Phaseolus vulgaris is comprised of black bean.

In certain embodiments, the orally ingested food composition contains at least about 0.1% to 25% weight/weight cooked, dehydrated, and powdered navy bean of the total food composition.

In certain embodiments, the orally ingested food composition contains at least about 0.1% to 25% weight/weight cooked, dehydrated, and powdered black bean of the total food composition.

In certain embodiments, the orally ingested food composition contains at least about 15% weight/weight cooked, dehydrated, and powdered Phaseolus vulgaris of the total food composition.

In certain embodiments, the orally ingested food composition contains at least about 1% weight/weight to about 25% weight/weight cooked, dehydrated, and powdered Phaseolus vulgaris of the total food composition.

An embodiment of the present invention may further comprise administering an orally ingested food composition containing cooked, dehydrated, and powdered Phaseolus vulgaris to animals.

An embodiment of the present invention may further comprise administering an orally ingested food composition containing cooked, dehydrated, and powdered Phaseolus vulgaris to dogs.

An embodiment of the present invention may further comprise administering an orally ingested food composition comprised containing cooked, dehydrated, and powdered Phaseolus vulgaris to cats.

An embodiment of the present invention may further comprise administering an orally ingested food composition containing cooked, dehydrated, and powdered Phaseolus vulgaris to humans.

An embodiment of the present invention may further comprise a method of treating obesity in animals comprising administering an orally ingested food composition containing cooked, dehydrated, and powdered Phaseolus vulgaris in at least about 25% weight/weight of the total food composition.

An embodiment of the present invention may further comprise a method of treating associated metabolic disorders of obesity in animals comprising administering an orally ingested food composition containing cooked, dehydrated, and powdered Phaseolus vulgaris in at least about 25% weight/weight of the total food composition.

An embodiment of the present invention may further comprise a method of treating associated metabolic disorders of obesity by administering an orally ingestible food composition of the present invention.

An embodiment of the present invention my further comprise the associated metabolic disorders are comprised of osteoarthritis, insulin resistance, hyperglycemia, cardiac dysfunction, respiratory disease, cranial cruciate ligament injury, kidney disease, and cancer.

An embodiment of the present invention may further comprise a method wherein the orally ingestible food composition of the present invention is administered for at least 14 days.

An embodiment of the present invention may further comprise a method wherein the orally ingestible food composition of the present invention is administered for at least 28 days.

An embodiment of the present invention may further comprise a method of decreasing serum cholesterol levels in animals by at least about 1% to at least about 23% by administering the orally ingestible food composition of the present invention.

An embodiment of the present invention may further comprise a wet or dry food composition of the orally ingested food composition of the present invention.

In certain embodiments, the orally ingested food composition contains at least about 0.1% to 25% weight/weight cooked, dehydrated, and powdered Phaseolus vulgaris of the total food composition.

In certain embodiments, the orally ingested food composition contains 25% weight/weight cooked, dehydrated, and powdered Phaseolus vulgaris of the total food composition.

An embodiment of the present invention may further comprise an orally ingestible food composition containing cooked, dehydrated, and powdered Phaseolus vulgaris, wherein the Phaseolus vulgaris is comprised of navy bean or black bean.

In certain embodiments, the orally ingested food composition contains at least about 0.1% to 25% weight/weight cooked, dehydrated, and powdered Phaseolus vulgaris of the total food composition, and wherein the Phaseolus vulgaris is comprised of navy bean or black bean.

### BRIEF DESCRIPTION OF THE DRAWINGS

To further clarify the above and other advantages and features of the one or more embodiments of the present invention, a more particular description of the one or more embodiments of the present invention is rendered by reference to specific embodiments thereof, which are illustrated in the appended drawings. It should be appreciated that these drawings only depict typical of the one or more embodiments of the present invention and are therefore not to be considered limiting in its scope. The one or more embodiments of the present invention are described and explained with additional specificity and detail through the use of the accompanying drawings listed below.

FIG. 1 is a diagram describing the timeline and study design for the two experimental studies.

FIG. 2 is a principal component analysis of canine fecal metabolome for the first experimental study after consuming either the control diet or the cooked, dehydrated, and powdered navy bean diet that was 25% weight/weight of the total food composition, after four weeks.

FIG. 3 is the change in cholesterol levels from canine subjects of the first experimental study from baseline (zero weeks) to four weeks.

FIG. 4 is a graph showing the percentage weight loss over time of canine subjects from the second experimental study at two and four weeks after beginning the control, navy bean, or black bean diet.

FIG. 5 is a bar chart showing the percentage weight loss over time of canine subjects from the second experimental study at two and four weeks after beginning the control diet.

FIG. 6 is a bar chart showing the percentage weight loss over time of canine subjects from the second experimental study at two and four weeks after beginning the black bean diet.

FIG. 7 is a bar chart showing the percentage weight loss over time of canine subjects from the second experimental study at two and four weeks after beginning the navy bean diet.

FIG. 8 is a graph showing the changes in cholesterol levels in canine subjects from the second experimental study from baseline (zero weeks) to four weeks.

FIG. 9 is a graph showing the percentage cholesterol reduction in canine subjects from the second experimental study from baseline (zero weeks) to four weeks.

FIG. 10 is a bar chart showing the change in glucose levels over time of canine subjects from the second experimental study from baseline (zero weeks) to four weeks for the control, black bean, and navy bean diets.

FIG. 11 is a bar chart showing the change in total protein levels over time of canine subjects from the second experimental study from baseline (zero weeks) to four weeks for the control, black bean, and navy bean diets.

FIG. 12 is a bar chart showing the change in alkaline phosphatase levels over time of canine subjects from the second experimental study from baseline (zero weeks) to four weeks for the control, black bean, and navy bean diets.

FIG. 13 is a bar chart showing the change in blood urea nitrogen levels over time of canine subjects from the second experimental study from baseline (zero weeks) to four weeks for the control, black bean, and navy bean diets.

### DETAILED DESCRIPTION OF THE EMBODIMENTS

Dry bean (Phaseolus vulgaris L.) consumption has shown chronic disease fighting activity in humans, as they are low glycemic index food with protein, fiber, minerals, essential vitamins, and bioactive compounds. However, Phaseolus vulgaris L. have gone unnoticed for use in non-human commercial food and feed formulations. Despite the success of plant-based nutrients in dog food, dry bean, Phaseolus vulgaris L., a food crop of global agricultural and nutritional importance, has not been exploited for use in commercial pet food formulations.

Phaseolus vulgaris L. was selected for the two experimental studies because of its reported health benefits and availability in cooked and dehydrated powdered form. Digestibilities of the starch and fiber components of uncooked (emphasis added) legumes have been evaluated for canines and exhibited lower digestibility when compared to other carbohydrate sources. Bednar, G. E., et al. J. Nutr. 131:276-286 (2001). Additionally, uncooked legumes (beans and/or peas) have been known to increase flatulence because of their high fiber content.

The prevalence of obesity and/or associated metabolic disorders has increased for humans and non-humans alike. Obesity, a term which is well-known in the art, represents a serious threat to the health of animals because it increases the likelihood of associated diseases, such osteoarthritis, insulin resistance, hyperglycemia, cardiac dysfunction, respiratory disease, cranial cruciate ligament injury, kidney disease, and cancer. Lack of exercise and excess food often lead to weight increase. These diseases can be measured not only physically, but biochemically using biomarkers.

### Biomarkers for Obesity and Weight Loss

A biomarker is a parameter, chemical, physical, or biological, that can be used to measure the progress of disease or the effects of treatment. Biomarkers, for example, can help in early diagnosis, drug target identification, disease prevention, and drug response. Disease related biomarkers can give an indication of how a disease may development in a subject, or the probable effect of treatment on a subject. This in turn can help make decisions in the diagnosis of a disease or condition and the course of treatment for a subject. Several biomarkers have been identified for many diseases and are well-known in the art. The level of these biomarkers in a subject's blood serum is a good indication of whether the subject is for example, a healthy weight, or overweight.

Table 1 shows a list of several important biomarkers for animal health, using canines as an example. The biomarker type is shown in column one, column two shows the level of the biomarker in obese dogs, and column three shows the level of the biomarker in dogs after weight loss.

TABLE 1

| | Obese | Dogs after |
|---|---|---|
| Biomarker | dogs | weight loss |
| Alkaline phosphatase (ALP) | High | Low |
| Cholesterol | High | Low |
| Triglycerides | High | Low |
| Total protein | High | Low |
| Albumin | High | Low |
| Calcium | High | High |
| Phosphorous | High | Low |
| Glucose | High | Low |
| Creatinine | Low | High |
| Blood urea nitrogen | Low | High |
| Chloride | Low | Low |
| Globulin | | Low |
| Alanine aminotransferase (ALT) | | Low |
| Sodium | | Low |
| Magnesium | | High |
| Potassium | | High |

### Biomarker Types

Alkaline phosphatase or ALP, is a hydrolase enzyme responsible for removing the phosphate groups from a variety of molecules. Elevated levels of ALP may indicate blockage in the bile ducts of the liver, for example.

Cholesterol is a waxy steroid of a fat and is formed predominantly in the liver of vertebrates. Cholesterol is an important component of cell walls, however, high cholesterol levels have been linked to diseases such as cardiovascular disease, obesity, and cancer.

Triglycerides are an ester derived from glycerol and attached to three fatty acids. High levels of triglycerides have been linked to obesity.

Total protein is the total amount of protein in the blood. A total protein test report separates values for total protein, albumin, and globulin.

Albumin is one of the two major proteins in the blood and is made mainly in the liver. It promotes tissue growth and healing.

Calcium is one of the most abundant minerals found in the body, and is primarily stored in the bones and the teeth.

Phosphorous is a mineral that is important for the formation of bones and teeth, but also functions in the body's use of carbohydrates and fats, synthesis of protein, proper functioning of the kidneys, and cardiovascular maintenance.

Glucose is a simple sugar and is a primary source of energy for the body. High levels of blood glucose in blood serum may be a sign of pre-diabetes or diabetes.

Creatinine is a breakdown product of creatine and is usually indicative of good kidney function. If high levels of creatinine are present in the blood, then this may indicate that kidney function is abnormal.

Blood urea nitrogen measures the amount of nitrogen in your blood, as a waste product derived from the production of urea. Elevated levels may indicate abnormal kidney function or heart failure, for example.

Chloride is one of the most important electrolytes in the body and is measured in either the blood or urine. It helps maintain proper fluid balance, blood pressure, and blood volume in the body.

Globulin is one of the two major proteins in the blood and is made up of alpha, beta, and gamma type proteins. Certain globulins are made by the liver, while others are made by the immune system.

Alanine aminotransferase or ALT, is an enzyme mainly found in the liver, but also found in lesser amounts in the pancreas, muscles, heart, and kidneys. A test for this enzyme is usually done to determine the relative health of the liver.

Sodium is an element that is important for maintaining a body's proper blood volume and pressure, but is also essential to the proper function of the body's nerves and muscles.

Magnesium is an essential mineral that is important for the proper function of muscle contraction and relaxation, protein production, and numerous biochemical reactions in the body.

Potassium is an important mineral for the proper function of all cells, tissues, and organs in the human body. It is essential for proper heart function, kidney function, and muscle relaxation and contraction.

In the present specification, the term “animal” is understood to be comprising dogs, cats, rabbits, guinea pigs, mice, rats, birds, ferrets, and other domesticated livestock animals such as lamas, alpacas, mules, donkeys, chickens, horses, pigs, sheep, goats, buffalo, cattle and the like.

In the present specification, the term “dog” includes those dogs which are companion animals such as Canis familiaris, working dogs and the like. The term dog is synonymous with canine.

In the present specification, the term “cat” includes those cats which are companion animals such as Felis catus, Felis silverstrus catus and Felis domestica, known as domestic or house cats.

In the present specification, the term “humans” means Homo sapiens.

In the present specification, the term “weight/weight” means the weight an individual component as a percentage of the weight of the total composition. Weight/weight may sometimes also be abbreviated as w/w.

In the present specification, the term “ingestible food composition” means any composition that can be ingested by animals, cats, dogs, and humans.

### EXAMPLES

### Experimental Studies

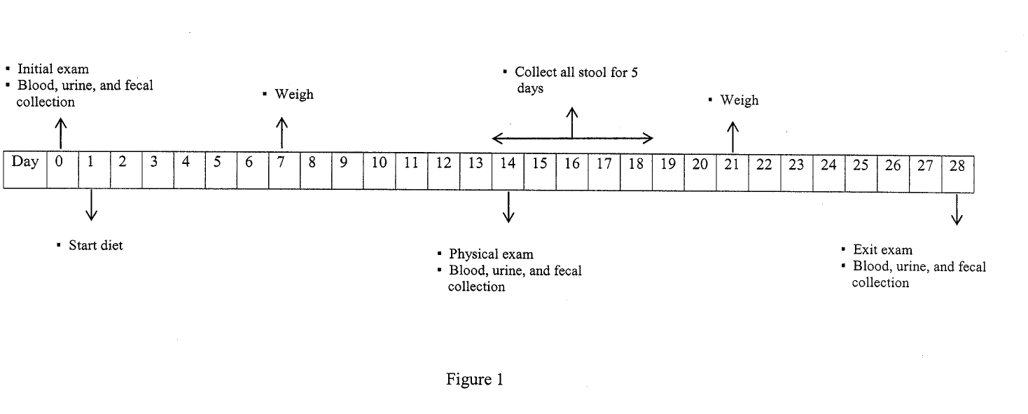

Two experimental studies were conducted to establish the safety and digestibility of cooked navy bean powder when incorporated into a canine diet formulation when compared to a macro and micro-nutrient matched control. The total length of each study was 28 days. Blood parameters were measured with standard clinical operating procedures at the Clinical Pathology Laboratory at Colorado State University. The biochemistry panel was analyzed using a clinical chemistry analyzer (Hitachi 917; Roche Diagnostics, Indianapolis, Ind.) and cell blood counts (CBC) was detected using an analyzer (Advia 120; Bayer, Tarrytown, N.Y.). All parameters required by the Association of American Feed Control Officials (AAFCO) were included in this panel. Blood and urinalysis was measured at baseline (zero weeks), 2 weeks post treatment, and 4 weeks post treatment. Fecal collection was taken at baseline to determine if there were any health problems in the subject canines. Control, cooked, dehydrated and powdered navy bean diet or cooked, dehydrated, and powdered black bean powder diet were given to the canine subjects at day 1. On day 7, the canine subjects were weighed. On day 14, canines were given a physical exam, and blood and urinalysis was taken. Fecal collections, or stool samples, were collected from day 14 through day 18 for digestibility analysis. On day 21, the canine subjects were weighed. On day 28, the last day of the study, canine subjects were given an exit examination and blood, urinalysis, and a fecal collection were taken. FIG. 1 shows an overview of the timeline for each experimental study and the corresponding days for actions taken in the studies.

### Experimental Study Number One

Twenty-one healthy, adult, free-living dogs were recruited to participate in a randomized, double blinded, and placebo-controlled canine dietary four week intervention study. All clinical trial operations, animal care procedures and collection of biological samples were approved for safety and digestibility of experimental research diets. Dogs were randomized in a 1:1 manner for equal allocation to study diets “A” or “B” and a body condition score or BCS, was determined by the study clinician during the baseline physical exam. BCS was measured on the following 9-point scale: 1-2=emaciated, 2-3=thin, 4-5=normal/moderate, 6=stout, 7=overweight, and 8-9=obese. Each dog received a study code number and both the owner and clinician were blinded to the assigned study arm. FIG. 1 shows the sample collection schedule for the 4 week study.

Table 2 shows the age, weight, body condition score, and gender of the 21 canine dietary intervention study participants. The sample size for the cooked, dehydrated, and powdered navy bean diet was 10 canines and the sample size for the control diet was 11. Differences in age, weight, and BCS were not significant between the two diet groups (P>0.05).

TABLE 2

| | |
|---|---|
| Navy Bean Diet | Control Diet |

| Parameter | Mean | SEM | Mean | SEM |
|---|---|---|---|---|
| Age (years) | 4 | ±0.50 | 3 | ±0.40 |
| Weight (kg) | 23.4 | ±1.47 | 28.2 | ±3.30 |

Median

| | | |
|---|---|---|
| BCS | 5 | 5 |

| | |
|---|---|
| Gender | Total Number |

| | | |
|---|---|---|
| Spayed female | 6 | 5 |
| Castrated male | 4 | 5 |
| Intact male | — | 1 |

Table 3 shows the breed of the 21 canine study participants. Column one shows the breed, column two shows the number of that breed in the cooked, dehydrated, and powdered navy bean diet, and column three shows the number of that breed in the control diet.

TABLE 3

| | Navy Bean | Control |
|---|---|---|
| Breed | Powder Diet | Diet |
| Australian Cattle Dog | 2 | 2 |
| Dalmatian | 1 | — |
| Hound Mix | — | 1 |
| Mixed (unknown) | 2 | 2 |
| Pit-bull Mix | — | 2 |
| Pointer | 1 | — |
| Retriever (Golden/Lab) | 1 | 3 |
| St. Bernard | — | 1 |
| Standard Poodle | 1 | — |
| Terrier/Terrier Mix | 2 | — |
| Total | 10 | 11 |

### Canine Diet Formulations

The compositions of the two canine formulations can be prepared either in wet or dry form, using conventional processes known to those skilled in the art. Two canine diet formulations were used in this study that meet the nutritional recommendations according to AAFCO 2008 Official Publication feeding guidelines. A formula similar to a commercially available adult canine diet formulation 27/12 (Archer Daniels Midland (ADM) Alliance Nutrition) was used for the 0% cooked, dehydrated, and powdered navy bean, placebo control. This formulation was used because it is an existing diet formulation of carbohydrate/fat ratio to compare to a formulation containing cooked, dehydrated, and powdered Phaseolus vulgaris L. The control diet was mixed and manufactured under the same conditions and locations as the cooked, dehydrated, and powdered navy bean diet. Diets were mixed and extruded in St. Charles, Mo. The cooked, dehydrated, and powdered navy bean diet was formulated to match the control diet in macronutrient and caloric content, except for the inclusion of 25% cooked, dehydrated, and powdered navy bean (VEGEFUL ADM Edible Bean Specialties, Decatur, Ill.). Both diets were prepared as dry food. Adjustment of major food ingredients, such as wheat and corn, were made to account for differences in the contribution of cooked, dehydrated, and powdered navy bean to macro and micronutrients and total caloric contents. The fatty acid content of both diets was matched as well. Marine-type long chain n−3 fatty acids were not present in either diet. The lipid profile of the diets was determined.

Both the cooked, dehydrated, and powdered navy bean diet and the control diet were given on an as-fed basis. The percentages of ingredients are listed for each study in Table 4. In Table 4, column one shows the ingredient, column two shows the percentage or unit of the ingredient in the total formula, column three shows the percentage or unit of the ingredient in the cooked, dehydrated, and powdered navy bean diet, and column four shows the percentage or unit of the ingredient in the control diet. LA is abbreviated for linoleic acid, ALA is abbreviated for alpha linoleic acid, AA is abbreviated for arachidonic acid, EPA is abbreviated for eicosapentaenoic acid, DHA is abbreviated for docosahexaenoic acid, K stands for kilo, and IU stands for international unit.

TABLE 4

| | | Navy Bean | Control |
|---|---|---|---|
| Ingredient | Unit | Diet | Diet |
| Navy bean cooked dehydrate | % | 25 | — |
| Meat and bone meal | % | 13.86 | 14.83 |
| Wheat grain | % | 1.67 | 14.5 |
| Wheat midds | % | 8.27 | 14.5 |
| Corn gluten meal | % | 9.35 | 14.24 |
| Brewer's rice | % | 12.5 | 12.5 |
| Corn | % | 11.25 | 11.25 |
| Poultry fat | % | 7.75 | 7.77 |
| Poultry by-product meal | % | 6.5 | 6.5 |
| Beet pulp | % | 1.0 | 1.0 |
| Ground flaxseed | % | 0.75 | 0.75 |
| Salt | % | 0.5 | 0.50 |
| Brewer's yeast | % | 0.5 | 0.5 |
| Monocalcium phosphate | % | 0.08 | 0.39 |
| Methionine | % | — | 0.07 |
| Crude fiber | % | 3.3 | 3.02 |
| Vitamin A | KIU/kg | 7500 | 7500 |
| Vitamin D | KIU/kg | 750 | 750 |
| Vitamin E | IU/kg | 93.75 | 93.75 |
| Folic acid | mg/kg | 0.263 | 0.263 |
| Vitamin B12 | mg/kg | 0.0375 | 0.0375 |
| n-6 fatty acids | % | 2.02 | 2.254 |
| n-6/n-3 fatty acids | Ratio | 10.06 | 10.91 |
| LA/ALA | Ratio | 9.79 | 10.54 |
| (LA + AA)/(ALA + EPA + DHA) | Ratio | 9.93 | 10.7 |

In Table 5, the organic matter, ash content, crude protein content, acid hydrolyzed fat, total dietary fiber, and gross energy were compared between the cooked, dehydrated, and powdered navy bean diet and the control diet. Column one shows the macro ingredients, column two shows the unit of the macro ingredient, column three shows the percentage or unit of the macro ingredient in the total formula of the cooked, dehydrated, and powdered navy bean diet, and column four shows the percentage or unit of the macro ingredient in the total formula of the control diet.

TABLE 5

| | | Navy | Control |
|---|---|---|---|
| Ingredient | Unit | Bean Diet | Diet |
| Organic matter | % | 46.67 | 48.1 |
| Ash | % | 8.17 | 8.63 |
| Crude protein | % | 29.91 | 31.15 |
| Acid hydrolyzed fat | % | 13.58 | 14.0 |
| Total dietary fiber | % | 3.18 | 2.95 |
| Gross energy | Kcal/kg | 4,957.57 | 4,967.9 |

### Canine Diet Instruction

Canine owners were instructed to feed only the research diet provided by study clinical coordinator for the entire study duration and to measure out a prescribed amount of food for canine consumption each day. The prescribed daily caloric consumption was determined by body weight and according to the canine's normal feeding habits (i.e., one or two feedings daily). Water was provided ad libitum. The total required daily caloric intake for each dog was calculated at the baseline study visit using the following formula:

kcal=110×Body Weight(kg)^{0.75}

This formula was used to maintain a stable weight in canines for the study duration. An inappropriate weight change was defined by a change of more or less than 2% per week or 4% change from each visit. Canine owners measured and recorded the volume of food offered and refused. The total amount consumed was calculated by subtracting the weight of the refused food from offered food. The canine owner completed a daily intake record for 28 days and a space was provided to record any intake from research diet that may impact study results.

### Blood and Urine Sample Collections

Blood samples were collected via jugular puncture at baseline, 2 weeks, and 4 weeks post intervention. At each visit, 1 mL of whole blood was collected into an evacuated red top tube without anticoagulant for biochemistry panel analysis. Another 1 mL of blood was collected into an evacuated lavender top tube containing EDTA (ethylenediaminetetraacetic acid) for complete blood counts (CBC), hemoglobin, and hematocrit determination.

### Fecal Scores and Sample Collection

Canine owners reported daily fecal scores using the following 3-point scale: 1=well formed, 2=soft, and 3=runny. A comment space was provided on the score sheet to obtain any observational changes per the owner's discretion. A four day (96 hour) total fecal collection was performed for the measurement of apparent macronutrient digestibility after 10 days of consuming 100% of the investigational, placebo control or the cooked, dehydrated, and powdered navy bean-containing, diets. Samples were collected daily and stored at −20° C. At the end of the collection period, the samples were weighed, pooled, and stored at −20° C. and then freeze-dried prior to proximate analysis. Urine samples were usually collected by the owner at home using provided specimen containers. In some cases when the owner was unable to obtain a urine sample, ultrasound guided cystocentesis was used.

### Proximate Analysis for Assessing Apparent Nutrient Digestibility

Proximate analysis of both of the research diets, and the 96 hour pooled fecal samples were performed according to AOAC (Association of Official Analytical Chemists) standard methods. Organic matter was calculated by subtracting ash from dry matter (DM). Gross energy was measured using oxygen bomb calorimetry. Crude fiber content was determined using the ANKOM Technology Crude Fiber Method. Study samples were coded and blinded for proximate analyses were performed.

Digestibility of protein, fat, carbohydrate, and total DM were calculated by the following formula where nutrients were measured in grams on a DM basis:

Nutrient digestibility(%)=((nutrient intake-nutrient in feces)/nutrient intake)×100

Metabolizable energy was calculated by the following formula:

Metabolizable energy=[Gross energy of food consumed−gross energy of feces collected−{(grams of protein consumed-grams of protein in feed}×correction factor for energy lost in urine)]/grams of food consumed×1000².

Food consumption was determined by recording feed intake, and dry matter fecal values were used. The correction factor for energy lost in urine was 1.25 kcal/g².

### Results of the First Experimental Study

A diverse set of breed participants were recruited for the first experimental study to provide broad representation of the canine population. Table 2 shows the mean age and standard error of the mean (SEM) age in years, weight in kilograms, median body condition score (BCS), and gender by study arm of the 21 dogs who participated in the study. No significant differences were determined at the baseline across treatments. The breeds of all dogs that participated in the study are listed in Table 3. Ten different known breeds and several mixed breeds were represented in the study in both diet groups.

### No Differences in Peripheral Blood Outcome Measures Between Treatments

In order to assess the safety of the 25% weight/weight cooked, dehydrated, and powdered navy bean dietary intake compared to a 0% bean, placebo control canine diet, blood diagnostic tests were conducted for all study participants at baseline, 2 weeks, and 4 weeks post intervention. No significant changes in AAFCO test protocol parameters including packed cell volume (PCV), hemoglobin (HGB), serum albumin concentrations, and serum alkaline phosphate activities (ALP) across treatments were detected. Additionally, no parameters were significantly changed or outside of the normal range in any of the dogs from baseline.

Table 6 shows the average serum levels of HGB, PCV value, albumin, and ALP for both groups at baseline, 2 weeks, and 4 weeks with the laboratory reported normal ranges. Column one shows the parameter measured, columns two and three show the mean value and SEM of the baseline value of the parameter for the cooked, dehydrated, and powdered navy bean diet, respectively; columns four and five show the mean value and SEM of the baseline value of the parameter for the control diet, respectively; columns six and seven show the mean value and SEM of the two week value of the parameter for the cooked, dehydrated, and powdered navy bean diet, respectively; columns eight and nine show the mean value and SEM of the two week value of the parameter for the control diet; columns ten and eleven show the mean value and SEM of the 4 week parameter for cooked, dehydrated, and powdered navy bean diet, respectively; columns twelve and thirteen show the mean value and SEM of the 4 week parameter for the control diet, respectively; and column fourteen shows the normal ranges for each parameter. Significance was tested by a one factor ANOVA across diet and time point. Differences between diet and time point were not significant (P>0.05, n=10).

In addition to the AAFCO required hemoglobin and packed cell volume, a full CBC and biochemistry profile were conducted to determine safety as shown in Tables 7 and 8 for the control diet and the cooked, dehydrated, and powdered navy bean diet, respectively. In Tables 7 and 8, column one shows the parameter measured, columns two and three show the mean and SEM value of the parameter at baseline, respectively; columns four and five show the mean and SEM value of the parameter at two weeks, respectively; and columns six and seven show the mean and SEM value of the parameter at four weeks, respectively; and column eight shows the normal ranges for the parameter. No significant adverse changes were observed in any of these parameters between the experimental diets and all parameters were determined to be within normal ranges, except for cholesterol levels, which were shown to be significantly different between the experimental diets.

TABLE 6

| | Baseline | | | | Two Weeks | | | | Four Weeks | | | | |
|---|---|---|---|---|---|---|---|---|---|---|---|---|---|
| | Navy Bean | | | | Navy Bean | | | | Navy Bean | | | | |
| | Diet | | Control | | Diet | | Control | | Diet | | Control | | Normal |
| Parameter | Mean | SEM | Mean | SEM | Mean | SEM | Mean | SEM | Mean | SEM | Mean | SEM | Range |
| HGB | 17.4 | ±0.42 | 17.6 | ±0.28 | 17.3 | ±0.40 | 17.8 | ±0.35 | 17.3 | ±0.32 | 18.2 | ±0.43 | 13.0-20.0 g/dL |
| PCV | 51.0 | ±1.10 | 51.0 | ±0.65 | 50.0 | 1.10 | 51.0 | ±0.96 | 49.0 | ±0.82 | 53.0 | ±1.40 | 40.0-55.0% |
| Albumin | 3.9 | ±0.08 | 3.9 | ±0.08 | 3.8 | 0.07 | 3.9 | ±0.08 | 3.8 | ±0.06 | 3.9 | ±0.07 | 2.5-4.0 mg/dL |
| ALP | 43.0 | ±6.30 | 62.0 | ±14.0 | 38.0 | 5.00 | 55.0 | ±13.0 | 36.0 | ±4.70 | 50.0 | ±11.00 | 20-142 IU/L |

TABLE 7

| | Control Diet | | | | | | |
|---|---|---|---|---|---|---|---|
| | Initial | | D14 | | D28 | | |
| Parameter | Mean | SEM | Mean | SEM | Mean | SEM | Normal Range |
| Nucleated | 9.27 | 0.68 | 9.52 | 0.90 | 8.15 | 0.73 | 4.5-15 × 10³/μl |
| Cells | | | | | | | |
| Segmented | 5.73 | 0.67 | 6.32 | 0.78 | 4.94 | 0.52 | 2.6-11 × 10³/μl |
| Neutrophils | | | | | | | |
| Lymphocytes | 2.43 | 0.32 | 1.93 | 0.25 | 2.18 | 0.38 | 1.0-4.81 × 10³/μl |
| Monocytes | 0.47 | 0.09 | 0.56 | 0.11 | 0.46 | 0.10 | 0.2-1.0 × 10³/μl |
| Plasma | 6.63 | 0.09 | 6.69 | 0.12 | 6.74 | 0.16 | 0.0 g/dl |
| Protein | | | | | | | |
| RBC | 7.50 | 0.11 | 7.58 | 0.12 | 7.71 | 0.16 | 5.5-8.5 × 10⁶/μl |
| HGB | 17.76 | 0.40 | 17.89 | 0.37 | 18.19 | 0.41 | 13.0-20.0 g/dl |
| PCV | 51.00 | 0.77 | 51.20 | 1.01 | 52.10 | 1.27 | 40.0-55.0% |
| MCV | 68.00 | 0.65 | 67.90 | 0.81 | 67.50 | 0.82 | 62.0-73.0 fl |
| MCHC | 34.80 | 0.31 | 35.10 | 0.36 | 35.20 | 0.40 | 33.0-36.0 g/dl |
| RDW | 12.66 | 0.10 | 12.93 | 0.06 | 12.94 | 0.08 | 12.0-15.0 |
| Platelets | 247.60 | 12.09 | 237.90 | 10.61 | 250.00 | 7.91 | 200.0-500.0 × 10³/μl |
| MPV | 11.06 | 0.43 | 10.66 | 0.35 | 10.38 | 0.17 | 7.5-14.6 fl |
| Glucose | 91.90 | 3.85 | 90.20 | 4.88 | 92.10 | 5.37 | 75-130 MG/DL |
| BUN | 17.10 | 0.86 | 24.40 | 1.49 | 23.40 | 1.63 | 7-32 MG/DL |
| Creatinine | 1.07 | 0.07 | 1.02 | 0.08 | 1.01 | 0.08 | 0.4-1.5 MG/DL |
| Phosphorus | 3.81 | 0.18 | 3.73 | 0.19 | 3.81 | 0.15 | 2.1-6 MG/DL |
| Calcium | 10.87 | 0.17 | 11.07 | 0.13 | 10.99 | 0.17 | 9.2-11.7 MG/DL |
| Magnesium | 2.20 | 0.08 | 2.22 | 0.05 | 2.26 | 0.07 | 1.9-2.7 MG/DL |
| Total Protein | 6.30 | 0.12 | 6.45 | 0.13 | 6.48 | 0.13 | 5.3-7.2 MG/DL |
| Albumin | 3.86 | 0.07 | 3.91 | 0.06 | 3.94 | 0.07 | 2.5-4.0 MG/DL |
| Globulin | 2.44 | 0.10 | 2.54 | 0.08 | 2.54 | 0.09 | 2.0-3.8 MG/DL |
| A/G Ratio | 1.62 | 0.07 | 1.56 | 0.05 | 1.57 | 0.07 | 0.8-1.6 Ratio |
| Cholesterol | 251.20 | 17.35 | 256.60 | 16.14 | 264.60 | 18.02 | 130-300 MG/DL |
| Total | 0.13 | 0.02 | 0.07 | 0.01 | 0.11 | 0.02 | 0.0-0.3 MG/DL |
| Bilirubin | | | | | | | |
| CK | 112.80 | 15.55 | 131.70 | 12.32 | 122.70 | 20.99 | 50-275 IU/L |
| ALP | 95.30 | 30.27 | 90.80 | 33.45 | 84.80 | 32.51 | 20-142 IU/L |
| ALT | 32.30 | 1.74 | 36.00 | 4.08 | 39.50 | 7.69 | 10-110 IU/L |
| AST | 28.00 | 2.10 | 29.00 | 1.20 | 29.40 | 2.57 | 16-50 IU/L |
| GGT | 2.10 | 0.50 | 1.00 | 0.35 | 1.50 | 0.38 | 0-9 IU/L |
| Sodium | 147.40 | 0.61 | 148.40 | 0.61 | 147.60 | 0.62 | 142-152 MEQ/L |
| Potassium | 4.33 | 0.08 | 4.43 | 0.08 | 4.31 | 0.10 | 4-5 MEQ/L |
| Chloride | 111.90 | 0.49 | 113.70 | 0.49 | 112.80 | 0.56 | 108.0-120.0 MEQ/L |
| Bicarbonate | 22.22 | 0.89 | 20.36 | 0.49 | 21.50 | 0.53 | 16-25 MEQ/L |
| Anion Gap | 17.50 | 1.00 | 18.90 | 0.56 | 17.60 | 0.96 | 13-22 CALC |
| Calc. | 293.00 | 1.06 | 298.30 | 1.12 | 296.30 | 1.50 | 284-304 mOsm/Kg |
| Osmolality | | | | | | | |
| Lipemia | 94.10 | 71.75 | 23.40 | 6.84 | 24.20 | 5.74 | 0-40 MG/DL |
| Hemolysis | 64.50 | 31.84 | 69.10 | 9.65 | 89.70 | 32.31 | 0-60 MG/DL |
| Icterus | 0.00 | 0.00 | 0.00 | 0.00 | 0.00 | 0.00 | 0-0 MG/DL |

TABLE 8

| | Navy Bean Powder Diet | | | | | | |
|---|---|---|---|---|---|---|---|
| | Initial | | D14 | | D28 | | |
| Parameter | Mean | SEM | Mean | SEM | Mean | SEM | Normal Range |
| Nucleated | 8.23 | 0.63 | 8.29 | 0.63 | 8.59 | 0.47 | 4.5-15 × 10³/μl |
| Cells | | | | | | | |
| Segmented | 5.18 | 0.59 | 5.16 | 0.58 | 5.80 | 0.56 | 2.6-11 × 10³/μl |
| Neutrophils | | | | | | | |
| Lymphocytes | 2.05 | 0.26 | 2.12 | 0.32 | 1.92 | 0.25 | 1.0-4.81 × 10³/μl |
| Monocytes | 0.46 | 0.05 | 0.37 | 0.09 | 0.41 | 0.05 | 0.2-1.0 × 10³/μl |
| Plasma | 6.70 | 0.07 | 6.52 | 0.13 | 6.60 | 0.19 | 0.0 g/dl |
| Protein | | | | | | | |
| RBC | 7.55 | 0.21 | 7.51 | 0.15 | 7.43 | 0.14 | 5.5-8.5 × 10⁶/μl |
| HGB | 17.75 | 0.41 | 17.84 | 0.29 | 17.76 | 0.33 | 13.0-20.0 g/dl |
| PCV | 51.50 | 1.07 | 51.33 | 0.79 | 50.40 | 0.95 | 40.0-55.0% |
| MCV | 68.60 | 0.81 | 68.33 | 0.81 | 67.90 | 0.80 | 62.0-73.0 fl |
| MCHC | 34.60 | 0.16 | 34.67 | 0.22 | 35.30 | 0.33 | 33.0-36.0 g/dl |
| RDW | 12.65 | 0.15 | 12.68 | 0.11 | 12.73 | 0.10 | 12.0-15.0 |
| Platelets | 197.60 | 19.97 | 206.44 | 13.27 | 232.70 | 22.77 | 200.0-500.0 × 10³/μl |
| MPV | 11.00 | 0.29 | 11.38 | 0.32 | 11.27 | 0.37 | 7.5-14.6 fl |
| Glucose | 95.90 | 3.45 | 91.70 | 2.84 | 99.10 | 2.64 | 75-130 MG/DL |
| BUN | 22.10 | 1.66 | 22.60 | 1.54 | 23.30 | 1.16 | 7-32 MG/DL |
| Creatinine | 1.07 | 0.04 | 1.01 | 0.05 | 0.96 | 0.05 | 0.4-1.5 MG/DL |
| Phosphorus | 3.58 | 0.20 | 3.93 | 0.10 | 3.47 | 0.19 | 2.1-6 MG/DL |
| Calcium | 10.75 | 0.12 | 10.86 | 0.12 | 10.64 | 0.16 | 9.2-11.7 MG/DL |
| Magnesium | 2.09 | 0.04 | 2.13 | 0.06 | 2.12 | 0.04 | 1.9-2.7 MG/DL |
| Total Protein | 6.31 | 0.14 | 6.43 | 0.16 | 6.30 | 0.17 | 5.3-7.2 MG/DL |
| Albumin | 3.83 | 0.09 | 3.89 | 0.09 | 3.84 | 0.07 | 2.5-4.0 MG/DL |
| Globulin | 2.48 | 0.13 | 2.54 | 0.15 | 2.46 | 0.17 | 2.0-3.8 MG/DL |
| A/G Ratio | 1.60 | 0.10 | 1.57 | 0.11 | 1.64 | 0.12 | 0.8-1.6 Ratio |
| Cholesterol | 229.00 | 8.34 | 220.80 | 7.81 | 216.20 | 10.92 | 130-300 MG/DL |
| Total | 0.13 | 0.02 | 0.11 | 0.02 | 0.11 | 0.01 | 0.0-0.3 MG/DL |
| Bilirubin | | | | | | | |
| CK | 123.50 | 25.76 | 109.10 | 14.99 | 127.70 | 14.02 | 50-275 IU/L |
| ALP | 41.80 | 6.52 | 37.40 | 5.08 | 35.90 | 4.67 | 20-142 IU/L |
| ALT | 49.10 | 13.62 | 35.40 | 2.95 | 44.80 | 7.94 | 10-110 IU/L |
| AST | 36.40 | 4.83 | 31.50 | 4.29 | 36.60 | 5.39 | 16-50 IU/L |
| GGT | 2.52 | 0.59 | 1.60 | 0.50 | 3.00 | 0.94 | 0-9 IU/L |
| Sodium | 149.10 | 0.99 | 149.30 | 0.79 | 148.10 | 0.89 | 142-152 MEQ/L |
| Potassium | 4.41 | 0.09 | 4.21 | 0.13 | 4.27 | 0.08 | 4-5 MEQ/L |
| Chloride | 115.50 | 0.65 | 115.90 | 0.96 | 114.50 | 0.58 | 108.0-120.0 MEQ/L |
| Bicarbonate | 20.81 | 0.52 | 20.27 | 0.60 | 20.71 | 0.43 | 16-25 MEQ/L |
| Anion Gap | 17.50 | 0.73 | 17.30 | 0.70 | 17.40 | 0.85 | 13-22 CALC |
| Calc. | 298.70 | 2.02 | 298.60 | 1.59 | 297.40 | 1.56 | 284-304 mOsm/Kg |
| Osmolality | | | | | | | |
| Lipemia | 10.70 | 4.18 | 17.60 | 5.17 | 32.20 | 14.10 | 0-40 MG/DL |
| Hemolysis | 49.50 | 10.64 | 55.70 | 10.43 | 52.50 | 12.20 | 0-60 MG/DL |
| Icterus | 0.00 | 0.00 | 0.00 | 0.00 | 0.00 | 0.00 | 0-0 MG/DL |

### Urinalysis Reveals Safety of Dietary Cooked, Dehydrated, and Powdered Navy Bean Intake

Although a urinalysis is not a required outcome criteria according to AAFCO guidelines for assessing safety of new dietary formulations, this additional safety measure was applied herein given the potential for beans at 25% weight/weight of diet to modulate overall metabolic status as well as liver and kidney metabolism. Urinalysis was conducted at baseline, 2 weeks, and 4 weeks intervention on all participants, where the results of USG (urine specific gravity) and urinary pH are shown in Table 9. Column one shows the parameter; columns two and three show the value and the SEM for the parameter at baseline for the cooked, dehydrated, and powdered navy bean diet, respectively; columns four and five show the value and SEM for the parameter at baseline for the control diet, respectively; columns six and seven show the value and the SEM for the cooked, dehydrated, and powdered navy bean diet at 2 weeks, respectively; columns eight and nine show the value and the SEM for the control diet at 2 weeks, respectively; columns ten and eleven show the value and the SEM for the cooked, dehydrated, and powdered navy bean diet at 4 weeks, respectively; and columns twelve and thirteen show the value and the SEM for the control diet at 4 weeks, respectively.

TABLE 9

| | Baseline | | | | 2 Weeks | | | | 4 Weeks | | | |
|---|---|---|---|---|---|---|---|---|---|---|---|---|
| | Navy Bean | | Control | | Navy Bean | | Control | | Navy Bean | | Control | |
| | Diet | | Diet | | Diet | | Diet | | Diet | | Diet | |
| Parameter | Mean | SEM | Mean | SEM | Mean | SEM | Mean | SEM | Mean | SEM | Mean | SEM |
| USG | 1.04 | 0.003 | 1.04 | 0.004 | 1.04 | 0.005 | 1.04 | 0.003 | 1.04 | 0.004 | 1.05 | 0.004 |
| pH | 6.55 | 0.411 | 6.45 | 0.474 | 5.9 | 0.379 | 6.86 | 0.279 | 6.15 | 0.342 | 6.36 | 0.405 |

All parameters were determined to be within normal and no significant differences were observed between groups. An intriguing trend was observed for urine pH such that the cooked navy bean powder diet group had an average pH at baseline 6.5 that decreased after 2 weeks to 5.5, and then normalized to an average baseline value of 6.5 at 4 weeks' time point. The control group demonstrated an opposite trend whereby the average urine pH was 6 at baseline, increased to a pH of 7 at 2 weeks, and then returned to urine pH of 6 at 4 weeks. There is no clinical significance for this transient response in urine pH between the cooked, dehydrated, and powdered navy bean diet and the control diet groups because both groups normalize at 4 weeks. These findings were reported herein as the experimental relevance of the acidic, yet transient urinary response to navy bean consumption may be important for future clinical dietary bean investigations.

### Nutrient Intake, Body Weights, Digestibility, Metabolizable Energy, and Fecal Characteristics

No significant differences in macronutrient intakes, apparent digestibility, fecal characteristics, and metabolizable energy were observed between the cooked, dehydrated, and powdered navy bean diet and control diet as shown in Table 10. In Table 10, column one shows protein, fat, and organic matter intakes; columns two and three show the mean values and SEM for the cooked, dehydrated, and powdered navy bean diet; and columns four and five show the mean values and SEM for the control diet. The standard error of the mean (SEM) for the cooked, dehydrated, and powdered navy bean diet was a sample size of 10, and the standard error of the mean (SEM) for the control diet was for a sample size of 11. Significance for intake, output, digestibility, and metabolizable energy were analyzed with a 2-factor ANOVA followed by Bonferroni's multiple comparison test. Significance for fecal scores was analyzed using an un-paired t-test. No significant differences (P<0.05) were found between groups.

As shown in Table 10, protein, fat, and organic matter intakes are reported on a dry matter basis. AAFCO metabolizable energy calculations assume apparent digestibility of 80% for protein, 90% for crude fat, and 84% for organic matter. Cooked, dehydrated, and powdered navy bean diet apparent digestibility was close to these values with the exception of organic matter, which was slightly lower. Average navy bean powder intake per kilogram of body weight was 3.7 g/day. Two dogs, one from each group, increased weight by 4% at the 2 week time point and the prescribed amount of food was reduced by 37.5 g for the cooked, dehydrated, and powdered navy bean diet and 32.6 g for the control diet. All other dogs maintained weight throughout the study of the duration.

TABLE 10

| | Navy Bean Diet | | Control Diet | |
|---|---|---|---|---|
| Parameter | Mean | SEM | Mean | SEM |
| Daily Nutrient Intake | | | | |
| Dry matter (g) | 1302 | ±76.4 | 1345 | ±122.4 |
| Crude protein (g) | 389.69 | −22.85 | 418.97 | −38.13 |
| Acid hydrolyzed fat (g) | 176.93 | −10.36 | 183.32 | −16.85 |
| Organic matter (g) | 608.06 | −35.66 | 641.97 | −58.58 |
| Apparent Digestibility | | | | |
| Dry matter | 68.58 | −5.6 | 68.89 | −5.08 |
| Crude protein (%) | 78.22 | −3.9 | 79.49 | −3.52 |
| Acid hydrolyzed fat (%) | 94.49 | −1.05 | 93.85 | −1.17 |
| Organic matter (%) | 75.56 | −4.39 | 76.21 | −3.69 |
| Metabolizable energy | 14184 | −154 | 11854 | −486 |
| (kJ/kg) | | | | |
| Fecal characteristics | | | | |
| Fecal output (g/d) | 367.41 | −62.64 | 414.98 | −63.01 |
| Fecal score | 1.1 | −0.053 | 1.127 | −0.045 |

As shown in Table 10, The metabolizable energy of the control diet are less than the cooked, dehydrated, and powdered navy bean diet due to one participant who ate a non-specified amount of high-energy horse feed during the 96 hour collection period. Exclusion of this datum results in a calculated metabolizable energy of 3288 kcal/kg±183. The total amount of fecal matter and fecal quality scores did not change between the two groups. An isolated incidence of vomiting and diarrhea was reported in both groups, and were reported as unrelated to diet by owner. None of the owners reported increased incidence of flatulence and both diets were reported as equally palatable to all study participants based on no differences detected in reported dietary intake or eating preferences determined by dog owners.

### Cholesterol Changes During the Study

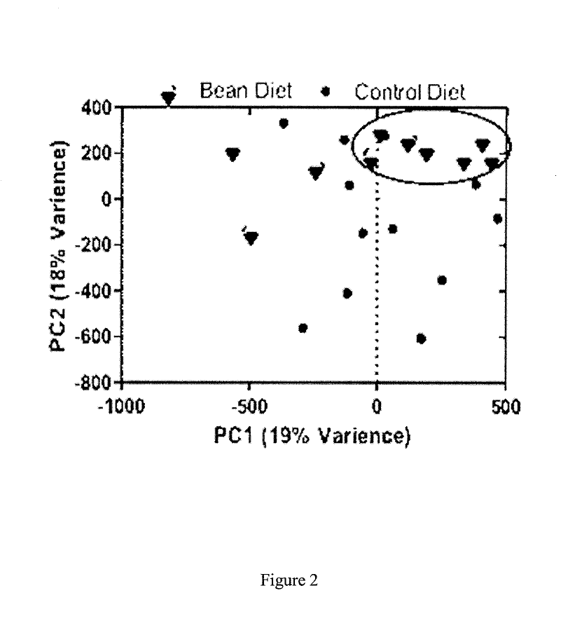

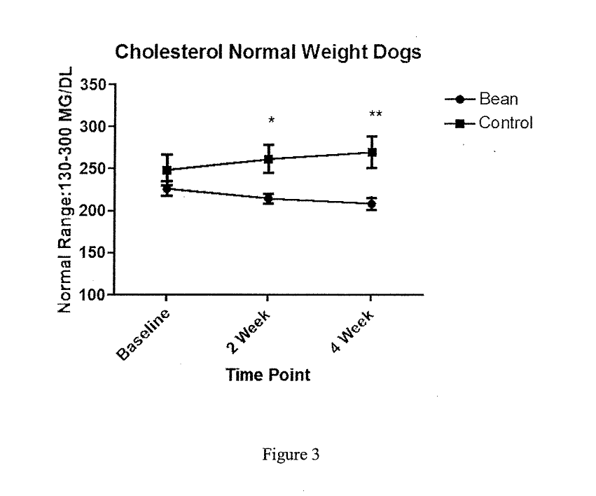

Additionally, similar metabolome characteristics were reported for both cooked, dehydrated, and powdered navy bean diet and the control diet, as shown in FIG. 2. Metabolome changes were measured as Principal component (PC) 2) (15%) on the y-axis over principal component (PC) 1 (21%) on the x-axis. These components show the maximum variation of small molecules in the entire set of fecal samples. A trend toward lower cholesterol was seen in the dogs consuming the cooked navy bean powder diet, as shown in FIG. 3 and Table 11. There was approximately an 8% decrease in cholesterol values at the end of the study for the cooked navy bean powder diet. Cholesterol values were significantly different between the two experimental diets at two weeks and four weeks at the 0.05 level of probability. The sample size for each of the diets was ten canines. Cholesterol values were measured in mg/dL. Column one shows the time frame, columns two and three show the cholesterol value and SEM for the cooked, dehydrated, and powdered navy bean diet, and columns four and five show the cholesterol value and the SEM for the control diet.

TABLE 11

| | |
|---|---|
| Navy Bean Diet | Control Diet |

| Time | Value | SEM | Value | SEM |
|---|---|---|---|---|
| Baseline | 226.50 | 8.61 | 248.50 | 18.27 |
| Two weeks | 214.60 | 5.63 | 261.60 | 16.46 |
| Four weeks | 208.40 | 7.34 | 269.70 | 18.79 |

Data from the first experimental study indicate that the results provide compelling support for the safe incorporation of dietary cooked, dehydrated, and powdered navy bean as no adverse changes were detected in diagnostic blood parameters that are routinely examined for the presence of canine disease or illness and an unexpected significant reduction in cholesterol values was shown for the navy bean powder cooked, dehydrated, and powdered navy bean diet.

### Second Experimental Study

Twenty-eight healthy, adult, free-living dogs were recruited to participate in a randomized, double blinded, and placebo-controlled canine dietary four week intervention study. All clinical trial operations, animal care procedures and collection of biological samples for safety and digestibility of experimental research diets were approved at a facility in Fort Collins, Colo. Dogs were randomized in a 1:1:1 manner for equal allocation to study diets “A”, “B” or “C” and a body condition score or BCS, was determined by the study clinician during the baseline physical exam. BCS was measured on same scale as the first experimental study. Only dogs with a BCS of 6-9 were enrolled in this study. Dogs with a BCS between 6-9 were randomized equally to each study arm.

Each dog received a study code number and both the owner and clinician were blinded to the assigned study arm. FIG. 1 shows the sample collection schedule for the 4 week study.

Table 12 shows the age, weight, body condition score, and gender of 28 canine dietary intervention study participants. Each diet group in the overweight dog study group had a target sample size, n=10 (i.e., the control diet, the cooked, dehydrated, and powdered navy bean diet, and the cooked, dehydrated, and powdered black bean diet). Baseline differences in age, weight, and BCS were not significant (P>0.05) across diet groups.

TABLE 12

| | Control | Black | Navy |
|---|---|---|---|
| Statistic | Diet | Bean Diet | Bean Diet |
| No. of dogs on the diet | 10/10 | 10/10 | 10/10 |
| Sex, male:female | 3:7 | 4:6 | 6:4 |
| Average age (years) | 6 ± 1.4 | 4.3 ± 1.7 | 4.6 ± 1.9 |
| Average weight (kg) | 33 ± 14.2 | 26.7 ± 10.1 | 28.8 ± 11 |
| Average BCS (out of 9) | 7.2 ± 0.92 | 7.7 ± 0.95 | 7.3 ± 0.82 |
| No. of dogs with change in | 1/10 | 3/10 | 4/10 |
| BCS after 4 weeks | | | |

### Canine Diet Formulations for Weight Loss

Given the safety and digestibility of cooked, dehydrated, and powdered navy bean in the first experimental study, a second bean type that is available in the cooked, dehydrated, and powdered form was added for investigation of efficacy in the second experimental study of weight loss. The cooked, dehydrated, and powdered navy bean and black bean diets were formulated to meet the nutritional recommendations according to AAFCO 2010 Official Publication Feeding guidelines. A formula similar to a commercially available adult canine diet formulation 27/12 (ADM Alliance Nutrition) was used for the 0% bean, placebo control. The control diet was mixed and manufactured under the same conditions and locations as the experimental cooked, dehydrated, and powdered navy bean and black bean diets. Diets were dry and mixed in St. Charles, Mo. Both the cooked, dehydrated, and powdered navy bean and black bean diets were formulated to match the control diet in macronutrient and caloric content, except for the inclusion of 25% weight/weight cooked, dehydrated, and powdered navy bean or black bean (VEGEFUL ADM Edible Bean Specialties, Decatur, Ill.). Adjustment of major food ingredients, such as wheat and corn, were made to account for differences in the contribution of cooked, dehydrated, and powdered navy bean and black bean to macro and micronutrients and total caloric contents. The fatty acid content of both diets was matched as well. Marine-type long chain n−3 fatty acids were not present in either diet. The lipid profile of the diets was determined.

All diets (control, and cooked, dehydrated, and powdered navy bean and black bean) were given on an as-fed basis. The percentages of ingredients are listed for each study in Table 13. In Table 13, column one shows the ingredient, column two shows the percentage of the ingredient in the control diet, column three shows the percentage of the ingredient in the cooked, dehydrated, and powdered navy bean diet, and column four shows the percentage of the ingredient in the cooked, dehydrated, and powdered black bean diet. LA is abbreviated for linoleic acid, ALA is abbreviated for alpha linoleic acid, AA is abbreviated for arachidonic acid, K stands for kilo, IU stands for international unit, EPA is abbreviated for eicosapentaenoic acid, DHA is abbreviated for docosahexaenoic acid, and AAFCO ME is abbreviated for Association of American Feed Control Officials ME estimation. The vitamin premix was from ADM Alliance in Quincy, Ill.

The following were provided per kilogram of cooked, dehydrated, and powdered navy bean and black bean diets: vitamin A, 7,500 IU; vitamin D, 750 IU; vitamin E, 93.75 IU; thiamine, 3.75 mg; riboflavin, 30 mg; pantothenic acid, 12 mg; niacin, 15 mg; pyridoxine, 1.875 mg; folic acid, 0.26 mg; vitamin B₁₂, 37.5 μg; choline, 534.4 mg; iron, 292 mg; copper, 15 mg; manganese, 31 mg; zinc, 200 mg; iodine, 2 mg; selenium, 0.7 mg.

The following were provided per kilogram of control diet: vitamin A, 7,500 IU; vitamin D, 750 IU; vitamin E, 93.75 IU; thiamine, 3.75 mg; riboflavin, 30 mg; pantothenic acid, 12 mg; niacin, 15 mg; pyridoxine, 1.875 mg; folic acid, 0.26 mg; vitamin B₁₂, 37.5 μg; choline, 534.4 mg; iron, 302.8 mg; copper, 16 mg; manganese, 44 mg; zinc, 213 mg; iodine, 2.6 mg; selenium, 0.6 mg.

The last six rows show the organic matter, ash content, crude protein content, crude fat, crude fiber, and gross energy were compared between the cooked, dehydrated, and powdered navy bean diets and the control diet. Column one shows the macro ingredients, column two shows the percentage of the ingredient in the control diet, column three shows the percentage of the ingredient in the cooked, dehydrated, and powdered navy bean diet, and column four shows the percentage of the ingredient in the cooked, dehydrated, and powdered black bean diet.

TABLE 13

| | | Navy | Black |
|---|---|---|---|
| | Control, % | Bean, % | Bean, % |
| | (as-fed | (as-fed | (as-fed |
| Ingredient | basis) | basis) | basis) |
| Navy bean (cooked, dehydrated) | — | 25.00 | — |
| Black bean (cooked, dehydrated) | — | — | 25.00 |
| Poultry meal | 19.53 | 19.61 | 19.00 |
| Wheat grain | 19.00 | 3.62 | 2.66 |
| Wheat midds | 19.00 | 9.42 | 11.61 |
| Corn grain | 16.10 | 19.00 | 17.67 |
| Brewer's rice | 10.00 | 10.17 | 10.00 |
| Pork and bone meal | 7.32 | 2.56 | 3.95 |
| Poultry fat | 3.00 | 3.00 | 3.00 |
| Ground flaxseed | 1.00 | 1.00 | 1.00 |
| Menhaden special select | 1.00 | 1.00 | 1.00 |
| Brewer's yeast | 1.00 | 1.00 | 1.00 |
| MonoCalcium Phosphate 2 | — | 1.00 | 0.68 |
| Digest dog dry | 1.0 | 1.00 | 1.00 |
| Calcium carbonate | 0.80 | 1.47 | 1.28 |
| Salt | 0.50 | 0.50 | 0.50 |
| Vitamin premix | 0.50 | 0.50 | 0.50 |
| Potassium chloride | 0.14 | 0.05 | 0.05 |
| Choline chloride | 0.10 | 0.10 | 0.10 |
| Analyzed Composition | | | |
| n-6 Fatty acids | 1.45 | 1.18 | 1.21 |
| n-6/n-3 Fatty Acids, ratio | 5.94 | 4.82 | 4.93 |
| LA/ALA, ratio | 6.93 | 4.17 | 5.11 |
| (LA + AA)/(ALA + EPA + DHA), | 10.7 | 9.93 | 9.93 |
| ratio | | | |
| AAFCO ME, kcal/kg | 2,479.2 | 2,497.7 | 2,529.3 |
| DM, % | 90.86 | 91.85 | 91.85 |
| | % of DM | | |
| Organic matter | 91.37 | 91.83 | 91.83 |
| Ash | 7.84 | 8.48 | 8.19 |
| Crude protein | 25.25 | 25.40 | 25.40 |
| Crude fat | 8.27 | 8.00 | 8.00 |
| Crude fiber | 3.31 | 3.38 | 3.22 |
| Gross energy, kcal/kg | 4,967.90 | 4,957.57 | 4,957.57 |

### Results for the Second Experimental Study

### Weight Loss in Canine Subjects

Table 14 shows the percentage weight loss of the canine subjects during the four week experimental study. Dietary intake for all dogs in each of the experimental diet groups was calculated according to the following formula: Baseline weight (kg)-(baseline weight (kg)×(0.1 if BCS 6, 0.2 if BCS 7, 0.3 if BCS 8, or 0.4 if BCS 9)).

Caloric intake for most dogs was reduced 40% and the following equation was used to determine the total Kcal/day that each dog needs: (110×(ideal weight̂0.75))×0.6

The total kcal per day was converted to total grams of each diet per day by dividing Kcal per day from Kcal diet per gram weight of diet. These formulas and steps show how the total grams/day that each dog needs to achieve weight loss in the second experimental study was determined.

In Table 14, Column one shows the time frame, columns two and three show the percentage weight loss and the SEM for the control diets, respectively; columns four and five show the percentage weight loss and SEM for the cooked black bean powdered diet, respectively; and columns six and seven show the percentage weight loss and SEM for the cooked navy bean powdered diet.

Results show that by the end of the four week study, canines on the control diet lost 4.04% of their initial body weight, canines on the cooked, dehydrated, and powdered black bean diet lost 5.0% of their initial body weight, and canines on the cooked, dehydrated, and powdered navy bean diet lost more than their other diets counterparts, 6.42% of their initial body weight.

TABLE 14

| Time | Control Diet | | Black Bean Diet | | Navy Bean Diet | |
|---|---|---|---|---|---|---|
| 2 weeks | 3.20 | 0.59 | 3.10 | 0.88 | 3.50 | 0.80 |
| 4 weeks | 4.04 | 0.97 | 5.00 | 1.22 | 6.42 | 1.06 |

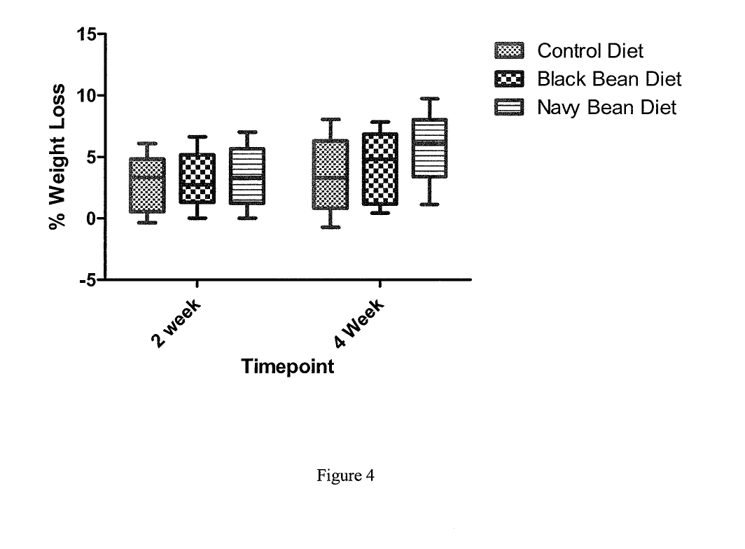

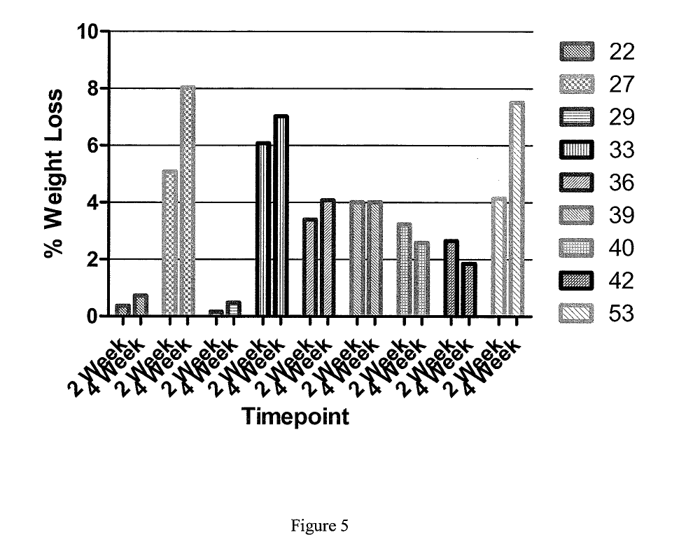

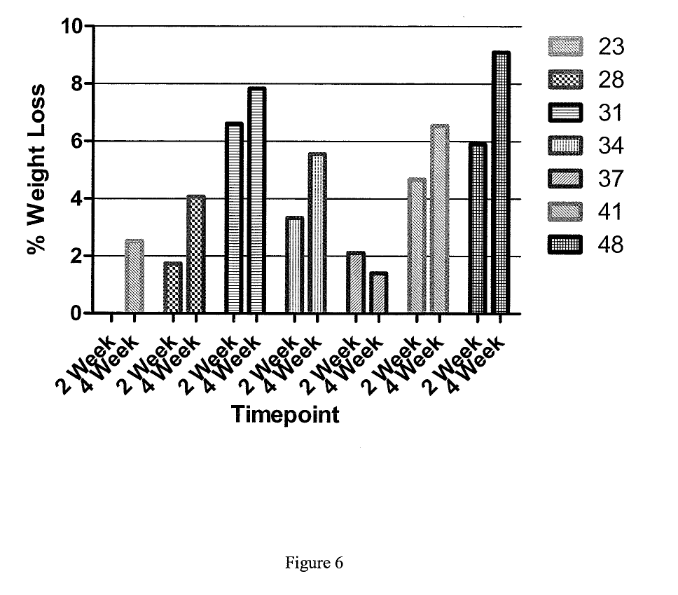

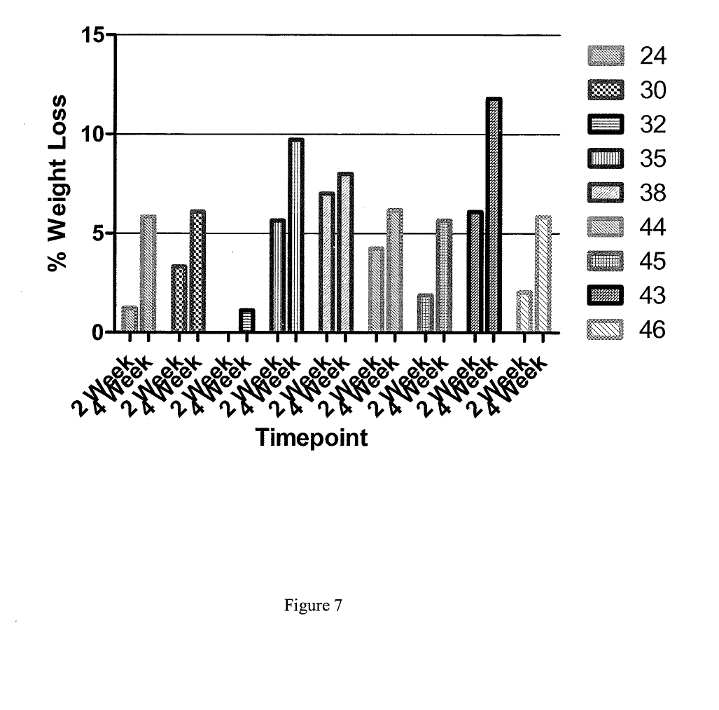

Additionally, FIGS. 4-7 show the weight loss over time for each diet group, as well as the weight loss within each individual diet group per canine subject.

### Measurements Identified on the CSU Chemistry Panel

The following list of blood parameters in Table 15 that are included in the metabolic panel are either significant or not significant for assessing metabolic changes during weight loss. This table is used as a guide to assess whether dietary incorporation of cooked, dehydrated, and powdered navy bean or black bean alters metabolic status differently from the control diet during the weight loss process. CSU units are measured as MEQ/L instead of mmol/L. S means significant at the P<0.1 level and NS means not significant

TABLE 15

| Measurement | Significance |
|---|---|
| Glucose, mg/dL | S |
| Alanine aminotransferase, U/L | NS |
| Alkaline phosphatase, U/L | S |
| Cholesterol, mg/dL | S |
| Total bilirubin, mg/dL | NS |
| Total protein, g/dL | S |
| Creatinine, mg/dL | S |
| Blood urea nitrogen, mg/dL | S |
| Albumin: globulin | NS |
| Albumin, g/dL | S |
| Calcium, mg/dL | S |
| Phosphorous, mg/dL | S |
| Chloride, mmol/L | S |
| Potassium, mmol/L | NS |
| Magnesium, mg/dL | NS |
| Sodium, mmol/L | NS |

### Cholesterol Changes During the Study

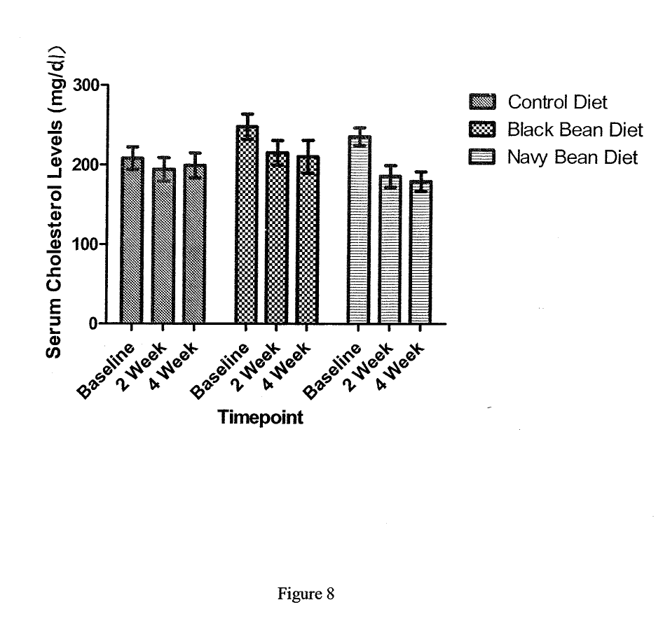

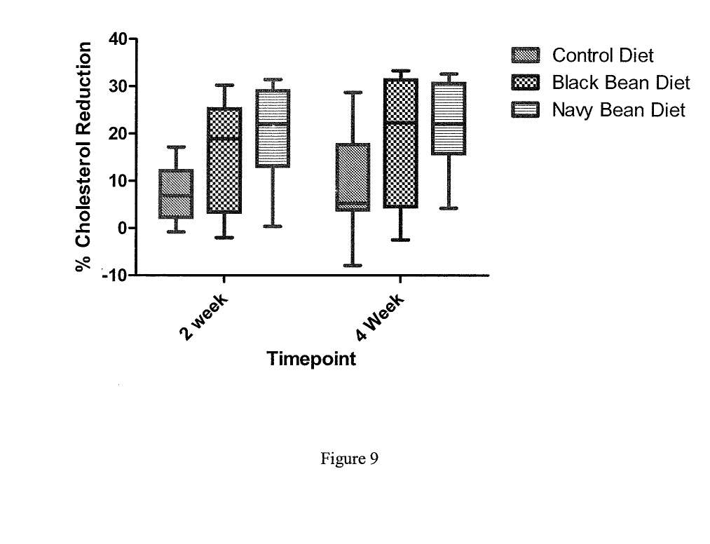

As reported in the first experimental study, a trend toward lower cholesterol was seen in the canines consuming the cooked, dehydrated, and powdered navy bean and black bean diets, as shown in FIGS. 8-9 and Table 16. There was approximately a 19.42% decrease in cholesterol values at the end of the study for the cooked, dehydrated, and powdered black bean diet and a 22.25% decrease in cholesterol values at the end of the study for the cooked, dehydrated, and powdered navy bean diet. Cholesterol levels for the control diet decreased by approximately 2.9% for the control diet. Cholesterol values for the bean diets were significantly different between the control diet at two weeks and four weeks. Cholesterol values were measured in mg/dL. Column one shows the time frame, columns two, three, and four show the cholesterol value, SEM, and sample size for the control diet; columns four, five, and six show the cholesterol value, SEM, and sample size for the cooked, dehydrated, and powdered black bean diet; and columns seven, eight, and nine show the cholesterol value, SEM, and sample size for the cooked, dehydrated, and powdered navy bean diet.

TABLE 16

| | Diet | | | | | | | | |
|---|---|---|---|---|---|---|---|---|---|
| | Control | | | Black Bean | | | Navy Bean | | |
| Time | Value | SEM | N | Value | SEM | N | Value | SEM | N |
| Base- | 208.20 | 13.97 | 10 | 247.80 | 15.87 | 10 | 235.40 | 11.14 | 10 |
| line | | | | | | | | | |
| 2 weeks | 194.20 | 14.71 | 10 | 215.13 | 15.43 | 8 | 185.56 | 13.69 | 9 |
| 4 weeks | 199.00 | 15.71 | 9 | 210.29 | 20.66 | 7 | 179.11 | 12.16 | 9 |

### Serum Glucose Levels in Canines During the Study

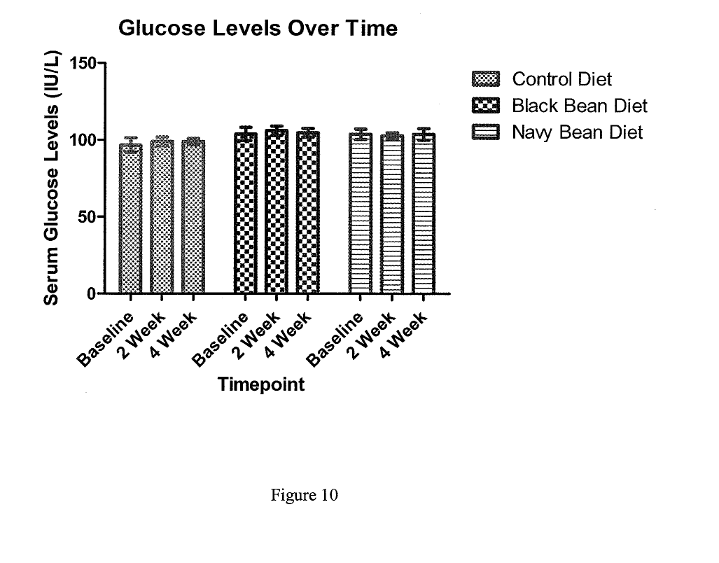

Table 17 and FIG. 10 show the serum glucose levels during the second experimental study, as broken down by diet group. Serum glucose levels were measured in IU/L. In Table 17, column one shows the time in days, columns two and three show the mean and SEM serum glucose levels of the control diet group; columns four and five show the mean and SEM serum glucose levels of the cooked, dehydrated, and powdered black bean diet group; and column six and seven show the mean and SEM serum glucose levels of the cooked, dehydrated, and powdered navy bean diet group. Results indicated that there were significant differences between the diet groups. Beans are a low glycemic index food that have been shown to decrease fasting levels in humans. Our results indicate that there were no significant differences between the diet groups after four weeks. Further investigation of blood glucose levels is required with beans after 2-6 months during weight loss.

TABLE 17

| | Diet | | | | | | | | |
|---|---|---|---|---|---|---|---|---|---|
| | Control | | | Black Bean | | | Navy Bean | | |
| Time | Mean | SEM | N | Mean | SEM | N | Mean | SEM | N |
| 0 | 101.2 | 5.59 | 10 | 106.10 | 3.34 | 10 | 105.2 | 3.09 | 10 |
| 14 | 102.4 | 4.00 | 10 | 106.63 | 2.77 | 8 | 103.11 | 1.90 | 9 |
| 28 | 103.00 | 4.50 | 9 | 105.71 | 2.63 | 7 | 103.89 | 3.18 | 9 |

### Serum Total Protein Levels in Canines During the Study

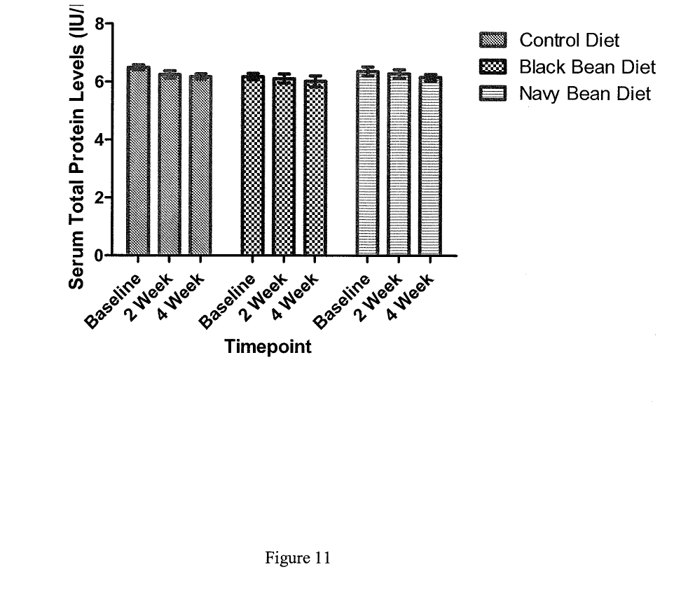

Table 18 and FIG. 11 show the serum total protein levels during the study, as broken down by diet group. Serum total protein levels were measured in IU/L. In Table 18, column one shows the time in days, columns two and three show the mean and SEM serum total protein levels of the control diet group; columns four and five show the mean and SEM serum total protein levels of the cooked, dehydrated, and powdered black bean diet group; and columns six and seven show the mean and SEM serum total protein levels of the cooked, dehydrated, and powdered navy bean diet group. Total protein did not change significantly over the four week study, but increased protein in a diet has proven to decrease hunger and in turn decrease the number of calories consumed which leads to weight loss.

TABLE 18

| | Diet | | | | | | | | |
|---|---|---|---|---|---|---|---|---|---|
| | Control | | | Black Bean | | | Navy Bean | | |
| Time | Mean | SEM | N | Mean | SEM | N | Mean | SEM | N |
| 0 | 6.49 | 0.09 | 10 | 6.18 | 0.11 | 10 | 6.36 | 0.15 | 10 |
| 14 | 6.25 | 0.13 | 10 | 6.11 | 0.16 | 8 | 6.28 | 0.15 | 9 |
| 28 | 6.18 | 0.09 | 9 | 6.01 | 0.19 | 7 | 6.16 | 0.11 | 9 |

### Serum Alkaline Phosphatase Levels in Canines During the Study

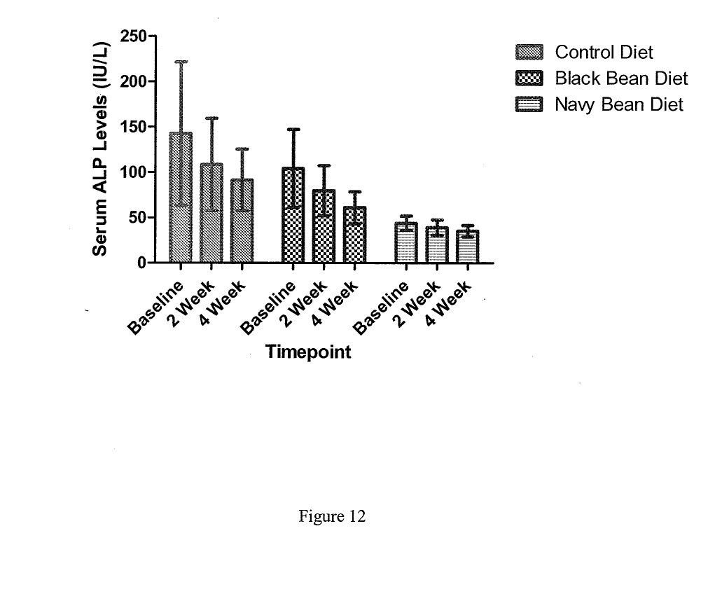

Table 19 and FIG. 12 show the serum alkaline phosphatase levels during the study, as broken down by diet group. Serum alkaline phosphatase levels were measured in IU/L. In Table 19, column one shows the time in days, columns two and three show the mean and SEM serum alkaline phosphatase levels of the control diet group; columns four and five show the mean and SEM serum alkaline phosphatase levels of the cooked black bean powdered diet group; and column six and seven show the mean and SEM serum alkaline phosphatase levels of the cooked navy bean powdered diet group. Serum alkaline phosphatase can be elevated when bones are under extra stress due to obesity. Arthritis can occur because of this. When weight is lost, joints are under less stress which causes alkaline phosphatase to decrease.

TABLE 19

| | Diet | | | | | | | | |
|---|---|---|---|---|---|---|---|---|---|
| | Control | | | Black Bean | | | Navy Bean | | |
| Time | Mean | SEM | N | Mean | SEM | N | Mean | SEM | N |
| 0 | 142.50 | 79.08 | 10 | 104.20 | 42.99 | 10 | 43.90 | 7.79 | 10 |
| 14 | 108.50 | 50.97 | 10 | 79.75 | 27.60 | 8 | 39.00 | 8.57 | 9 |
| 28 | 91.44 | 34.13 | 9 | 60.86 | 17.69 | 7 | 35.33 | 6.31 | 9 |

### Serum Blood Urea Nitrogen in Canines During the Study

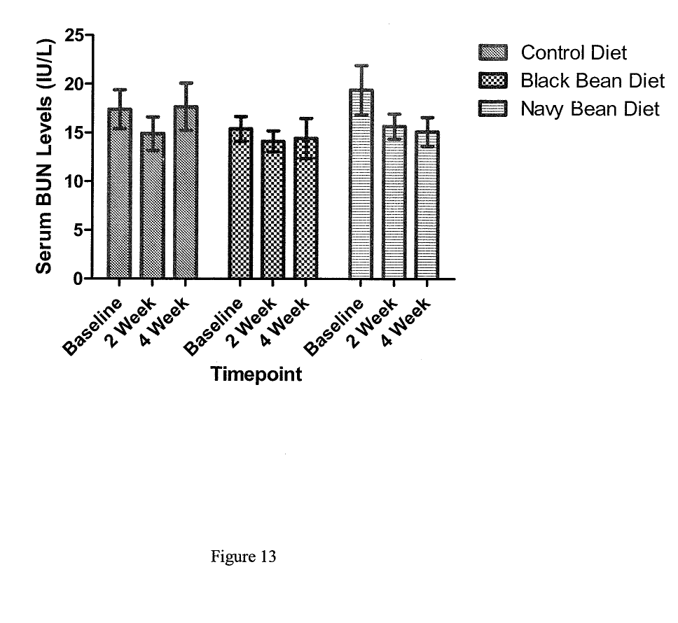

Table 20 and FIG. 13 show the serum blood urea nitrogen levels during the study, as broken down by diet group. Serum blood urea nitrogen levels were measured in IU/L. In Table 20, column one shows the time in days, columns two and three show the mean and SEM serum blood urea nitrogen levels of the control diet group; columns four and five show the mean and SEM serum blood urea nitrogen levels of the cooked, dehydrated, and powdered black bean diet group; and column six and seven show the mean and SEM serum blood urea nitrogen levels of the cooked, dehydrated, and powdered navy bean diet group. During obesity the liver may be developing disease which causes blood urea nitrogen to decrease. When weight is lost the liver is able to function correctly again and blood urea nitrogen returns to a normal level.

TABLE 20

| | Diet | | | | | | | | |
|---|---|---|---|---|---|---|---|---|---|
| | Control | | | Black Bean | | | Navy Bean | | |
| Time | Mean | SEM | N | Mean | SEM | N | Mean | SEM | N |
| 0 | 17.40 | 1.99 | 10 | 15.40 | 1.26 | 10 | 19.40 | 2.54 | 10 |
| 14 | 14.90 | 1.72 | 10 | 14.13 | 1.08 | 8 | 15.67 | 1.28 | 9 |
| 28 | 17.67 | 2.43 | 9 | 14.43 | 2.07 | 7 | 15.11 | 1.48 | 9 |

Data from the second experimental study further indicate that the results provide compelling support for the safe incorporation of dietary cooked, dehydrated, and powdered navy bean or black bean as no adverse changes were detected in diagnostic blood parameters that are routinely examined for the presence of canine disease or illness and an unexpected significant reduction in cholesterol values was shown for the cooked, dehydrated, and powdered navy bean or black bean diets. These findings support important metabolic changes with Phaseolus vulgaris L. containing diets during weight loss. A number of other blood weight loss biomarkers (i.e., glucose, blood urea nitrogen, alkaline phosphatase) may require more time, about 2-6 months to show significant changes across diet groups.

Additional Experimental Studies Using an Orally Ingested Food Composition Containing Phaseolus vulgaris L.

Orally ingestible formulations containing cooked, dehydrated, and powdered Phaseolus vulgaris L. can also be made for other animals including cats, rabbits, guinea pigs, mice, rats, birds, ferrets, and other domesticated livestock animals such as lamas, alpacas, mules, donkeys, chickens, horses, pigs, sheep, goats, buffalo, cattle and the like, and humans.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions, and sub-combinations as are within their true spirit and scope.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention.

We claim:

1. An orally ingested food composition containing cooked, dehydrated, and powdered Phaseolus vulgaris.

2. The orally ingested food composition of claim 1 containing at least about 0.1% to 25% weight/weight of cooked, dehydrated, and powdered Phaseolus vulgaris of the total food composition.

3. The orally ingested food composition of claim 2, wherein the Phaseolus vulgaris is comprised of navy bean.

4. The orally ingested food composition of claim 2, wherein the Phaseolus vulgaris is comprised of black bean.

5. The orally ingested food composition of claim 1 containing at least about 1% to at least about 15% weight/weight of cooked, dehydrated, and powdered Phaseolus vulgaris of the total food composition.

6. The orally ingested food composition of claim 1 containing at least about 1% to at least about 25% weight/weight of cooked, dehydrated, and powdered Phaseolus vulgaris of the total food composition

7. The orally ingested food composition of claim 1, wherein the orally ingested food composition is administered to the group comprising animals and humans.

8. A method of treating obesity in animals and humans comprising administering the orally ingested food composition of claim 1.

9. A method of treating associated metabolic disorders of obesity comprising administering the orally ingested food composition of claim 1.

10. The method of claim 9, wherein the associated metabolic disorders of obesity are comprised of osteoarthritis, insulin resistance, hyperglycemia, cardiac dysfunction, respiratory disease, cranial cruciate ligament injury, kidney disease, and cancer.

11. The method of claim 8, wherein the food composition is administered for at least 14 days.

12. The method of claim 8, wherein the food composition is administered for at least 28 days.

13. The method of claim 9, wherein the food composition is administered for at least 14 days.

14. The method of claim 9, wherein the food composition is administered for at least 28 days.

15. A method of decreasing serum cholesterol levels in animals and humans by at least about 1% to at least about 23% by administering the food composition of claim 1.

16. The orally ingested food composition of claim 1, wherein the orally ingested food composition can be made as a wet or dry food composition.

17. The orally ingested food composition of claim 1 containing at least about 0.1% to 25% weight/weight of cooked, dehydrated, and powdered Phaseolus vulgaris of the total food composition.

18. The orally ingested food composition of claim 1 containing 25% weight/weight of cooked, dehydrated, and powdered Phaseolus vulgaris of the total food composition.

19. The orally ingested food composition of claim 1, containing at least about 0.1% to 25% weight/weight cooked; dehydrated, and powdered Phaseolus vulgaris of the total food composition, and wherein the Phaseolus vulgaris is comprised of navy bean or black bean.

20. The orally ingested food composition of claim 1, wherein the Phaseolus vulgaris is comprised of navy bean or black bean.
